(19) United States
(12) Patent Application Publication
(10) Pub. No.: US 2024/0122202 A1
(43) Pub. Date: Apr. 18, 2024

(54) CHOCOLATE HAVING STRONG AROMA CHARACTERISTICS, AND METHOD FOR PRODUCING CHOCOLATE HAVING STRONG AROMA CHARACTERISTICS

(71) Applicant: MEIJI CO., LTD., Tokyo (JP)

(72) Inventors: Takashi KATAGIRI, Tokyo (JP); Masayuki SATO, Tokyo (JP); Keisuke KIMURA, Tokyo (JP); Noriyuki MANADA, Tokyo (JP)

(73) Assignee: MEIJI CO., LTD., Tokyo (JP)

(21) Appl. No.: 18/392,256

(22) Filed: Dec. 21, 2023

Related U.S. Application Data
(62) Division of application No. 17/290,019, filed on Nov. 23, 2021.

(30) Foreign Application Priority Data
Nov. 5, 2018 (JP) 2018-208411
Nov. 5, 2018 (JP) 2018-208412

(51) Int. Cl. A23G 1/32; A23G 1/00

(52) U.S. Cl. CPC A23G 1/32; A23G 1/002; A23V 2002/00

(57) ABSTRACT

The invention provides a chocolate having strong aroma characteristics. The aroma characteristics may include at least one of a fruity aroma and a floral aroma, and isoamyl acetate may be contained as an aroma component. The invention also provides a novel method for producing a chocolate having strong aroma characteristics. The method includes a step of crushing at least a cacao raw material and a sugar raw material in a sealed crusher.

### TECHNICAL FIELD

The invention relates to a chocolate having strong aroma characteristics, and a method for producing a chocolate having strong aroma characteristics.

### BACKGROUND ART

Chocolates are widely distributed as popular food, and in recent years, products provided with flavors and textures in accordance with preferences of eaters by blending a specific component, adjusting a blending ratio of a component, etc. have been developed (for example, Patent Documents 1 to 3).

A chocolate is conventionally produced through: a grinding step of grinding roasted cacao nibs to obtain a cacao mass; a mixing step of mixing the cacao mass and an auxiliary raw material; a refining step of refining the mixed chocolate raw material; a conching step of conching the refined chocolate raw material; a tempering step of crystallizing the chocolate raw material by controlling the temperature; a cooling and solidifying step of solidifying, by cooling, the chocolate raw material put in a mold, and the like.

### PRIOR ART DOCUMENT

### Patent Document

Patent Document 1: JP-A-2017-18087
Patent Document 2: JP-A-2017-221138
Patent Document 3: JP-A-2016-187322

### SUMMARY OF INVENTION

The inventors made earnest studies for developing chocolates having various flavors and textures, to find the following: In a conventional method for producing a chocolate, cacao nibs are ground into a cacao mass with an open system device, such as a grinder in a grinding step, and therefore, a volatile aroma component contained in a cacao raw material is unavoidably vigorously scattered. It was also found that the aroma component is unavoidably scattered because a refining step and a conching step where a roll refiner and the like are used are also conducted in an open system.

As a result, even if cacao beans having a strong aroma are selected as the raw material of a chocolate, it has been difficult to produce a chocolate having strong aroma characteristics by making the best of the aroma characteristics of the cacao beans.

An object of the invention is to provide a novel chocolate having strong aroma characteristics, and a novel method for producing a chocolate for producing a chocolate having strong aroma characteristics.

According to the invention, a novel chocolate having strong aroma characteristics, and a novel chocolate production method for producing a chocolate having strong aroma characteristics as described below can be provided.

1. A chocolate having strong aroma characteristics.

2. The chocolate according to 1, wherein the aroma characteristics include at least one of a fruity aroma and a floral aroma.

3. The chocolate according to 1 or 2, wherein the aroma characteristics include at least a fruity aroma.

4. The chocolate according to any one of 1 to 3, wherein the aroma characteristics include at least a floral aroma.

5. The chocolate according to any one of 1 to 4, comprising isoamyl acetate as an aroma component.

6. The chocolate according to 5, wherein, when the aroma component is adsorbed and concentrated by SPME fiber and measured by gas chromatography mass spectrometry, a peak area of the isoamyl acetate is 27,000 or more.

7. The chocolate according to 5 or 6, further comprising acetic acid as an aroma component.

8. The chocolate according to 7, wherein, when the aroma component is adsorbed and concentrated by SPME fiber and measured by gas chromatography mass spectrometry, a ratio of a peak area of the isoamyl acetate to a peak area of the acetic acid is 0.000710 or more.

9. The chocolate according to any one of 1 to 8, comprising 80% or more of an aroma component contained in a cacao raw material.

10. A method for producing a chocolate, comprising a step of crushing at least a cacao raw material and a sugar raw material in a sealed crusher.

11. The method for producing a chocolate according to 10, wherein a chocolate having strong aroma characteristics is able to be produced.

12. The method for producing a chocolate according to 11, wherein the aroma characteristics include at least one of a fruity aroma and a floral aroma.

13. The method for producing a chocolate according to 11 or 12, wherein the aroma characteristics include at least a fruity aroma.

14. The method for producing a chocolate according to any one of 11 to 13, wherein the aroma characteristics include at least a floral aroma.

15. The method for producing a chocolate according to 13, wherein an aroma component is at least one of isoamyl acetate and acetic acid.

16. The method for producing a chocolate according to any one of 10 to 15, wherein all chocolate raw materials are crushed as a whole in the sealed crusher in the step of crushing.

17. The method for producing a chocolate according to any one of 10 to 16, wherein the sealed crusher is a ball mill, a stone mill, a jet mill, a colloid mill, a refiner conche, a disc mill, or a bead mill.

18. The method for producing a chocolate according to any one of 10 to 17, wherein 80% or more of an aroma component contained in the cacao raw material is able to be remained in the chocolate.

According to the invention, a novel chocolate having strong aroma characteristics, and a novel chocolate production method for producing a chocolate having strong aroma characteristics can be provided.

### BRIEF DESCRIPTION OF DRAWINGS

FIG. 1 is a diagram illustrating analysis results of isoamyl acetate in chocolates of Example 1 and Comparative Example 1 and commercially available chocolates.

FIG. 2 is a diagram illustrating analysis results of acetic acid in the chocolates of Example 1 and Comparative Example 1 and the commercially available chocolates.

FIG. 3 is a diagram illustrating analysis results of aroma components (isoamyl acetate and acetic acid) in chocolate bases obtained in Example 1 and Comparative Example 1, in which residual ratios (%) of isoamyl acetate and acetic acid in each chocolate base, obtained based on the amounts of isoamyl acetate or acetic acid in a cacao raw material of 100%, are illustrated.

FIG. 4 is a diagram illustrating analysis results of isoamyl acetate in chocolates of Examples 2 and 3 and Comparative Examples 7 to 10.

FIG. 5 is a diagram illustrating analysis results of linalool in chocolates of Example 3 and Comparative Example 8.

### DESCRIPTION OF EMBODIMENTS

(Chocolate having Strong Aroma Characteristics)

Preferred embodiments of a chocolate according to the invention will now be specifically described.

The chocolate of the invention is characterized by strong aroma characteristics. The chocolate of the invention is produced by a novel production method as described below, and hence, diffusion of an aroma component mainly derived from cacao beans can be suppressed, and thus, a chocolate having strong aroma characteristics can be provided.

In general, examples of aroma characteristics of chocolates include a fruity aroma, a floral aroma, a nutty aroma, a roasted aroma, and a cacao aroma. Among these, aromas such as the fruity aroma and the floral aroma are derived mainly from cacao beans used as a raw material. Aromas such as the nut aroma and the cacao aroma not only are derived from cacao beans used as the raw material but also include a component developed through a process such as a roasting step of roasting the cacao raw material. The roasted aroma is largely influenced by a production process such as the roasting step.

All of these aromas are easily scattered due to heat and environmental influence because components for developing these aromas are highly volatile. It is the fruity aroma and the floral aroma that cannot be added during the production process and hence are required to keep their contents derived from the raw material.

In one aspect of the chocolate of the invention, the aroma characteristics include at least one of the fruity aroma and the floral aroma. In another aspect of the chocolate of the invention, the aroma characteristics include the fruity aroma.

One aspect of the chocolate of the invention is a chocolate in which a component for providing at least one of the fruity aroma and the floral aroma contained in the cacao raw material is kept at a high content. Another aspect of the chocolate of the invention is a chocolate in which a component for providing the fruity aroma, a component for providing the floral aroma, or components for providing the fruity aroma and the floral aroma, contained in the cacao raw material, are kept at a high content. The component for providing the fruity aroma is preferably isoamyl acetate. The component for providing the floral aroma is preferably linalool.

In one aspect, the chocolate of the invention preferably contains isoamyl acetate as an aroma component. In another aspect, the chocolate of the invention preferably contains isoamyl acetate and acetic acid as the aroma component.

In the invention, an analysis value of an aroma component means a peak area obtained when the aroma component contained in the chocolate is adsorbed and concentrated by a SPME fiber and measured by gas chromatography mass spectrometry. Specifically, an analysis value of an aroma component refers to a peak area measured as follows: crushing 2 g of a chocolate sample, sealing the crushed chocolate sample in a 20 ml vial container, retaining the container at 37° C. for 15 minutes, absorbing and concentrating the resultant headspace by a SPME fiber (DVB/CAR/PDMS) for 30 minutes, and measuring the peak area by gas chromatography mass spectrometry (column: polar column, column oven temperature: 40° C. to 220° C., temperature increasing rate: 3° C./min, carrier gas: He). A peak of isoamyl acetate is a peak corresponding to a mass-to-charge ratio m/z of 87, and a peak of acetic acid is a peak corresponding to a mass-to-charge ratio m/z of 60. A peak of linalool is a peak corresponding to a mass-to-charge ratio m/z of 93.

In one aspect, the chocolate of the invention is characterized in that isoamyl acetate is contained as an aroma component, and that the isoamyl acetate has an analysis value of 27,000 or more. The analysis value of the isoamyl acetate is preferably 30,000 or more, and more preferably 35,000 or more. In another aspect, the chocolate of the invention preferably contains isoamyl acetate and acetic acid as the aroma component.

In one aspect, the chocolate of the invention contains linalool as an aroma component, and the linalool has an analysis value of 16,000 more, preferably 18,000 or more, and more preferably 20,000 or more.

In another aspect, the chocolate of the invention is characterized in that isoamyl acetate and acetic acid are contained as the aroma component, and that a ratio of an analysis value of the isoamyl acetate to an analysis value of the acetic acid is 0.000710 or more. The ratio of the analysis value of the isoamyl acetate to the analysis value of the acetic acid is preferably 0.000800 or more, more preferably 0.000900 or more, and further preferably 0.000950 or more.

The analysis value of the isoamyl acetate, the analysis value of the acetic acid, and the ratio of these analysis values can be measured by gas chromatography mass spectrometry as described above.

In one aspect, the chocolate of the invention contains preferably 80% or more, more preferably 85% or more, further preferably 90% or more, and particularly preferably 95% or more of an aroma component contained in the cacao raw material.

(Method for Producing Chocolate)

Hereinafter a preferred embodiment of a method for producing a chocolate according to the invention will be specifically described.

The method for producing a chocolate according to the invention is characterized by including a step of crushing at least a cacao raw material and a sugar raw material in a sealed crusher. In the production method of the invention, diffusion of an aroma component mainly derived from cacao beans is suppressed, and hence a chocolate having strong aroma characteristics can be produced.

The chocolate of the invention can be produced by, for example, the production method characterized by including a step of crushing at least a cacao raw material and a sugar raw material in a sealed crusher. According to the production method of the invention, the diffusion of an aroma component mainly derived from cacao beans is suppressed, and hence a chocolate having strong aroma characteristics can be produced.

A general conventional method for producing a chocolate includes at least a mixing step of mixing raw materials, and a refining step of refining the raw materials, and further includes, before the mixing step, a grinding step of grinding a cacao raw material. In the conventional production method, each step is performed with a plurality of devices different among the steps, and as these devices, an open system device is used in some or all of the steps.

On the other hand, in the production method of the invention, the sealed crusher is used for performing the crushing step of crushing at least the cacao raw material and the sugar raw material, and hence, a chocolate having strong aroma characteristics, which could not be obtained by the conventional production method, can be produced.

In the invention, examples of the cacao raw material include cacao beans, cacao nibs, and a cacao mass. A cacao raw material containing a large amount of an aroma component can be cacao beans from Venezuela, Dominica, Madagascar, Brazil, Ecuador, Peru, and Sao Tome and Principe.

In one aspect, the production method of the invention may include, before the step of crushing at least a cacao raw material and a sugar raw material in a sealed crusher, a grinding step of grinding the cacao raw material in a/the sealed crusher. Thus, the grinding of the cacao raw material and the crushing of the ground cacao raw material and the sugar raw material can be continuously performed in a closed system, and hence, a chocolate having strong aroma characteristics can be produced.

In one aspect of the production method of the invention, all chocolate raw materials may be crushed as a whole in the sealed crusher in the crushing step. Thus, a chocolate can be efficiently produced through a smaller number of steps.

In the production method of the invention, an optional raw material known in this technical field may be added in addition to the cacao raw material and the sugar raw material. Examples of the optional raw material include cocoa butter, lecithin, and an emulsifier.

In the production method of the invention, the sealed crusher refers to a device for refining a chocolate raw material to be treated into a desired particle size in a closed space. Since the raw material is thus refined in the closed space, an aroma component contained in the raw material can be prevented from diffusing in the air, and hence strong aroma characteristics can be imparted to the chocolate to be produced.

Examples of the sealed crusher usable in the invention include, but are not limited to, a ball mill, a stone mill, a jet mill, a colloid mill, a refiner conche, a disc mill, and a bead mill. From the viewpoint of imparting a smooth texture in eating the chocolate, a crushing method is not especially limited as long as a particle size D₅₀ of a chocolate base obtained by the crushing treatment can be 30 grin or less. A particle size distribution and the particle size D₅₀ of the chocolate base can be measured with a laser diffraction particle size distribution measuring apparatus, and can be measured by, for example, a method described in an example below.

According to the production method of the invention, a chocolate base in which a component for providing at least one of the fruity aroma and the floral aroma contained in the cacao raw material can be kept at a high content even after the treatment can be obtained. Besides, in one aspect of the production method of the invention, a chocolate base in which a component for providing the fruity aroma, a component for providing the floral aroma, or components for providing the fruity aroma and the floral aroma can be kept at a high content even after the treatment can be obtained.

In one aspect of the production method of the invention, a chocolate base having a high content of isoamyl acetate, that is, one of indicator components of the fruity aroma, can be obtained. Besides, in another aspect of the production method of the invention, a chocolate base having a high content of acetic acid, that is, a component for making the fruity aroma easily felt, can be obtained.

A chocolate produced from the chocolate base obtained by the production method of the invention has an excellent quality with the fruity aroma and the floral aroma of cacao beans used as the raw material kept at a high content. The component for the fruity aroma is preferably isoamyl acetate. The component for the floral aroma is preferably linalool.

According to the production method of the invention, 80% or more, preferably 85% or more, more preferably 90% or more, and particularly preferably 95% or more of an aroma component contained in a cacao raw material can be allowed to remain in the chocolate. The aroma component is preferably a component for providing the fruity aroma, and/or a component for providing the floral aroma.

### EXAMPLES

The invention will now be further specifically described with reference to examples, and it is noted that the scope of the invention is not at all limited to the description of these examples.

### Example 1

A chocolate base was obtained by putting whole chocolate raw materials shown in Table 1 in a sealed crusher (ball mill), and crushing the thus mixed raw materials until a particle size D₅₀ of 30 μm or less could be obtained. The cacao mass was obtained by crushing cacao nibs derived from Brazilian cacao beans under a closed environment.

The particle size was measured on a volume basis using a laser diffraction particle size distribution measuring apparatus (SALD-2200, manufactured by Shimadzu Corporation). Specifically, the crushed chocolate raw materials were melted in a hot water bath at 50° C., 0.1 g of the resultant was dispersed in 10 g of isopropyl alcohol, and 0.05 g of the resultant was added into a measurement cell containing isopropyl alcohol to obtain a measurement sample. A measurement wavelength was set to 680 nm.

The thus obtained chocolate base was filled in a mold, cooled, and then released from the mold to obtain a chocolate.

TABLE 1
Chocolate Raw Materials and Blending Ratios

| Raw Material | Blending Ratio [wt %] |
|---|---|
| Cacao Mass | 60.0 |
| Sugar | 29.6 |
| Cocoa Butter | 10.0 |
| Lecithin | 0.3 |
| Emulsifier | 0.1 |
| Total | 100.0 |

### Comparative Example 1

The chocolate raw materials shown in Table 1 were used to produce a chocolate by a general conventional production method. Specifically, the cacao mass, the sugar, a part of the lecithin, and the emulsifier were mixed with a mixer, the resultant was refined with a roll refiner until the particle size D₅₀ of 30 μm or less could be obtained, the cocoa butter and the balance of the lecithin were added thereto, and the resultant was stirred and mixed to obtain a chocolate base. The cacao mass was obtained by crushing cacao nibs derived from Brazilian cacao beans with an open system grinder. The particle size was measured in the same manner as in Example 1. The chocolate base was filled in a mold, cooled, and then released from the mold to obtain a chocolate. It is noted that non-sealed devices were used as the grinder and the roll refiner.

Evaluation of Chocolate Base and Chocolate

(1) Analysis of Aroma Components

Aroma components of samples sampled from the cacao mass or cacao nibs used as the raw material and the chocolate bases obtained after the crushing treatment in Example 1 and Comparative Example 1 were analyzed. 2 g of each sample was crushed, sealed in a 20 ml vial container for analysis, and retained therein at 37° C. for 15 minutes, and the resultant headspace was adsorbed and concentrated by SPME (solid-phase microextraction) for 30 minutes to be subjected to gas chromatography mass spectrometry (GC/MS). Conditions for the GC/MS were as follows.
SPME fiber: DVB/CAR/PDMS
GC/MS column: polar column
Column oven temperature: 40° C. to 220° C., temperature increasing rate: 3° C./min
Carrier gas: He

As the aroma components, isoamyl acetate, that is, one of indicator components of the fruity aroma, and acetic acid, that is, a component for making the fruity aroma easily felt, were measured. A mass-to-charge ratio m/z of isoamyl acetate was set as 87, and a mass-to-charge ratio m/z of acetic acid was set as 60.

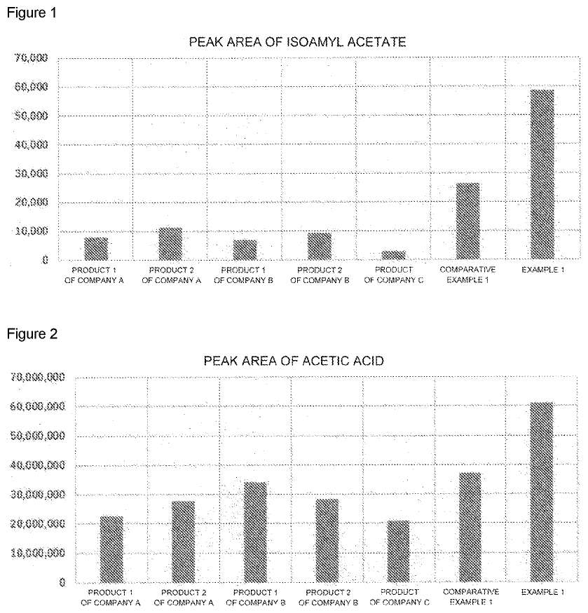

Peak areas of isoamyl acetate and acetic acid obtained in Example 1 and Comparative Example 1 are illustrated in FIG. 1 and FIG. 2.

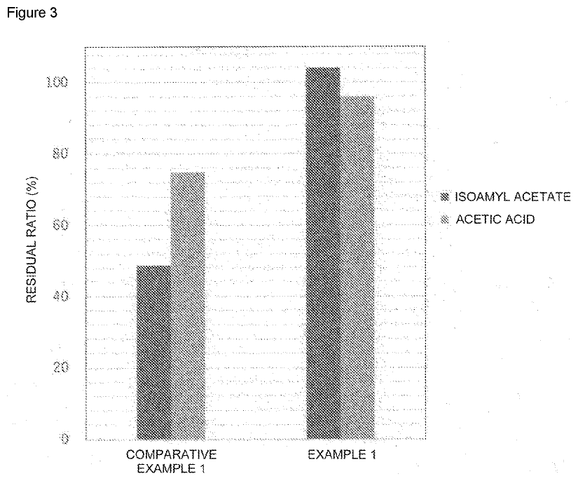

Based on the amount (peak area) of isoamyl acetate or acetic acid contained in the cacao raw material (cacao mass or cacao nibs) of 100%, a ratio of the amount (peak area) of isoamyl acetate or acetic acid in the chocolate base was calculated to be evaluated as a residual ratio (%). Results are illustrated in FIG. 3.

(2) Sensory Evaluation

The chocolates obtained in Example 1 and Comparative Example 1 were subjected to sensory evaluation performed by six chocolate expert panelists. As the sensory evaluation, the chocolates produced in Example 1 and Comparative Example 1 were evaluated for two items of acidity and a fruity aroma on a scale of −3 to +3 (0.5 increments), and an average of scores of the six panelists was calculated. Evaluation criteria were as follows: “−3: very weak”, “−2: weak”, “−1: rather weak”, “0: ordinary”, “+1: rather strong”, “+2: strong”, and “+3: very strong”. The panelists had been sufficiently trained to be able to give the same score to the same sample, and before the evaluation, all the panelists were identified themselves, with respect to each of flavors of the acidity and the fruity aroma, with how much the strength of the flavor should be increased to increase the score by 1. Results are shown in Table 2.

TABLE 2
Results of Sensory Evaluation of Chocolates

| | Acidity | Fruity Aroma |
|---|---|---|
| Example 1 | 0.75 | 1.50 |
| Comparative Example 1 | −1.83 | −1.50 |

As illustrated in FIG. 3, in the chocolate base of Example 1 to be used for producing a chocolate according to one aspect of the invention, the residual ratios of isoamyl acetate and acetic acid were 95% or more (104% and 96%, respectively). On the other hand, in the chocolate base of Comparative Example 1 obtained by the conventional production method, the residual ratio of isoamyl acetate was 49%, and the residual ratio of acetic acid was 75%.

In the chocolate base of Example 1 to be used for producing a chocolate according to one aspect of the invention, isoamyl acetate and acetic acid contained in the cacao raw material were kept also in the chocolate base at high contents of the residual ratios of 80% or more. In other words, the fruity aroma and the component for making it easily felt were both kept. On the other hand, in the chocolate base of Comparative Example 1 obtained by the conventional production method, the aroma components were scattered during the production process, and the residual ratios of isoamyl acetate and acetic acid in the chocolate base were both low.

Besides, in the chocolate base of Example 1 to be used for producing a chocolate according to one aspect of the invention, a residual ratio of a floral aroma equivalent or better than that of the fruity aroma is also attained. Also with respect to chocolates obtained in examples described below, both the floral aroma and the fruity aroma can be allowed to remain at residual ratios equivalent or better than those of Example 1.

Through the sensory evaluation, the chocolate obtained in Example 1 was evaluated to have a stronger fruity aroma than the chocolate of Comparative Example 1 obtained by the conventional production method.

### Comparative Examples 2 to 6

Among commercially available chocolate products, five chocolate products having a high cacao content were analyzed for the aroma components in the same manner as in Example 1. As the aroma components, contents (peak areas) of isoamyl acetate and acetic acid were measured to be compared with those of Example 1 and Comparative Example 1. The commercially available chocolate products are as follows:

a product 1 available from Company A, a product 2 available from Company A, a product 1 available from Company B, a product 2 available from Company B, and a product available from Company C.

Results of analysis values (peak areas) of the contents of the aroma components are illustrated in FIGS. 1 and 2. As illustrated in FIGS. 1 and 2, the contents of isoamyl acetate and acetic acid were obviously higher in the chocolate of the invention than in the commercially available chocolate products having a high cacao content.

A ratio of the analysis value (peak area) of the content of isoamyl acetate to the analysis value (peak area) of the content of acetic acid is shown in Table 3. The ratio of the analysis value of isoamyl acetate/analysis value of acetic acid was obviously higher in the chocolate of the invention than in the commercially available chocolate products having a high cacao content.

TABLE 3
Isoamyl Acetate Analysis Value/Acetic Acid Analysis Value

| | |
|---|---|
| Product 1 of Company A | 0.000345772 |
| Product 2 of Company A | 0.000404176 |
| Product 1 of Company B | 0.000204745 |
| Product 2 of Company B | 0.000328952 |
| Product of Company C | 0.000131334 |
| Comparative Example 1 | 0.000707226 |
| Example 1 | 0.000959230 |

### Example 2

Cacao beans from Dominica different from those of Example 1 were used to obtain a chocolate by employing a similar composition and similar steps to those of Example 1. The chocolate thus obtained was analyzed for the aroma components in the same manner as in Example 1.

### Comparative Example 7

The same raw materials as those of Example 2 were used to produce a chocolate by the conventional general production method in the same manner as in Comparative Example 1. The chocolate thus obtained was analyzed for the aroma components in the same manner as in Example 1.

### Example 3

Cacao beans from Peru different from those of Examples 1 and 2 were used to obtain a chocolate by employing a similar composition and similar process to those of Example 1. The chocolate thus obtained was analyzed for the aroma components in the same manner as in Example 1. As the aroma components, however, not only isoamyl acetate and acetic acid but also linalool was measured. A mass-to-charge ratio m/z of linalool was set as 93.

### Comparative Example 8

The same raw materials as those of Example 3 were used to produce a chocolate by the conventional general production method in the same manner as in Comparative Example 1. The chocolate thus obtained was analyzed for the aroma components in the same manner as in Example 1. As the aroma components, however, not only isoamyl acetate and acetic acid but also linalool was measured in the same manner as in Example 3. Peak areas of linalool obtained in Example 3 and Comparative Example 8 are illustrated in FIG. 5.

### Comparative Examples 9 and 10

Two commercially available chocolate products different from those used in Comparative Examples 2 to 6, and each containing cacao beans from Peru in a content of 70% as a cacao content were analyzed for the aroma components in the same manner as in Example 1.

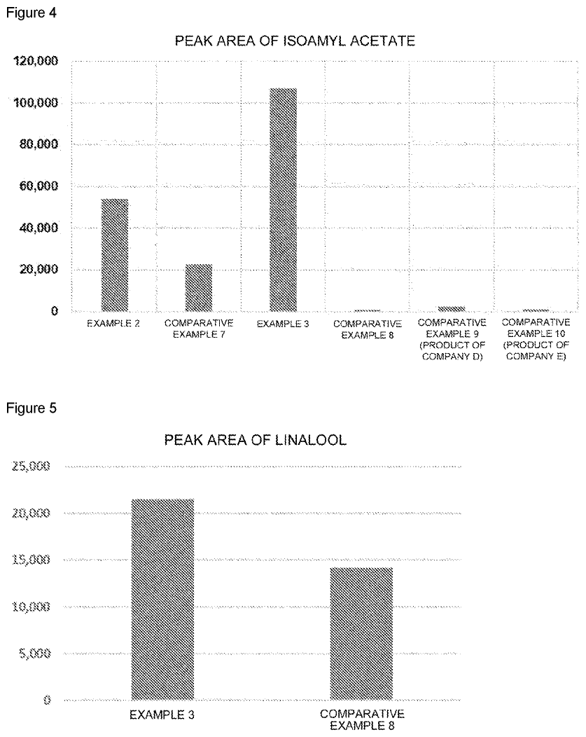

Results of analysis values (peak areas) of the contents of the aroma content (isoamyl acetate) are illustrated in FIG. 4, and a ratio of the analysis value (peak area) of the content of isoamyl acetate to the analysis value (peak area) of the content of acetic acid is shown in Table 4. As shown in FIG. 4 and Table 4, the content of isoamyl acetate was obviously higher, and the ratio of the analysis value of isoamyl acetate/analysis value of acetic acid was obvious higher in the chocolates of the invention than in the chocolates obtained by the conventional general production method, and the commercially available chocolate products containing a high content of cacao beans from Peru, which are generally regarded to have strong aroma characteristics.

Referring to FIG. 5, the content of linalool was obviously higher in the chocolate of Example 3 (peak area of linalool=21,505), that is, the chocolate of the invention, than in the chocolate of Comparative Example 8 (peak area of linalool=14,179) having the same composition and obtained by the conventional general production method.

TABLE 4
Isoamyl Acetate Analysis Value/Acetic Acid Analysis Value

| | |
|---|---|
| Example 2 | 0.00072091 |
| Comparative Example 7 | 0.00037300 |
| Example 3 | 0.00187608 |
| Comparative Example 8 | 0.00001540 |
| Comparative Example 9 | 0.00006077 |
| (Product of Company D) | |
| Comparative Example 10 | 0.00001457 |
| (Product of Company E) | |

Sensory Evaluation

The chocolates obtained in Example 3 and Comparative Example 8 were subjected to sensory evaluation performed by five chocolate expert panelists. As the sensory evaluation, the chocolates produced in Example 3 and Comparative Example 8 were evaluated for a floral aroma on a scale of +1 to +7 (0.5 point increments), and an average of scores of the five panelists was calculated. Evaluation criteria were as follows: “+1: very weak”, “+2: weak”, “+3: rather weak”, “+4: ordinary”, “+5: rather strong”, “+6: strong”, and “+7: very strong”. The panelists had been sufficiently trained to be able to give the same score to the same sample, and before the evaluation, all the panelists were identified themselves, with respect to a flavor of the floral aroma, with how much the strength of the flavor should be increased to increase the score by 1. Results are shown in Table 5.

TABLE 5
Result of Sensory Evaluation of Chocolates

| | Floral Aroma |
|---|---|
| Example 3 | 5.0 |
| Comparative | 2.0 |
| Example 8 | |

Through the sensory evaluation, the chocolate obtained in Example 3 was evaluated to have a stronger floral aroma than the chocolate of Comparative Example 8 obtained by the conventional production method.

### INDUSTRIAL APPLICABILITY

According to the invention, a chocolate that keeps aroma characteristics mainly derived from a cacao raw material and has strong aroma characteristics can be provided. The chocolate of the invention can satisfy a variety of preferences of eaters.

In a production method of the invention, it is possible to suppress the disappearance of aroma characteristics mainly derived from a cacao raw material during the production process, and it is possible to produce a chocolate having strong aroma characteristics. By the production method of the invention, it is possible to produce a chocolate capable of satisfying a variety of preferences of eaters.

Some embodiments and/or examples of the invention have been described so far, and those skilled in the art can make many changes in the exemplified embodiments and/or examples without substantially departing from the novel scope and effects of the invention. Accordingly, such many changes are encompassed within the spirits of the invention.

The entire contents of the documents cited herein and the application corresponding to a priority application according to Paris Convention are incorporated herein by reference.

1-18. (canceled)

19. A method for producing a chocolate, comprising a step of crushing at least a cacao raw material and a sugar raw material in a sealed crusher, and a grinding step of grinding the cacao raw material in the sealed crusher, before the step of crushing, wherein the cacao raw material in the grinding step is cacao nibs.

20. The method for producing a chocolate according to claim 19, wherein a chocolate having strong aroma characteristics is able to be produced.

21. The method for producing a chocolate according to claim 20, wherein the aroma characteristics include at least one of a fruity aroma and a floral aroma.

22. The method for producing a chocolate according to claim 20, wherein the aroma characteristics include at least a fruity aroma.

23. The method for producing a chocolate according to claim 20, wherein the aroma characteristics include at least a floral aroma.

24. The method for producing a chocolate according to claim 22, wherein an aroma component is at least one of isoamyl acetate and acetic acid.

25. The method for producing a chocolate according to claim 19, wherein all chocolate raw materials are crushed as a whole in the sealed crusher in the step of crushing.

26. The method for producing a chocolate according to claim 19, wherein the sealed crusher is a ball mill, a stone mill, a jet mill, a colloid mill, a refiner conche, a disc mill, or a bead mill.

27. The method for producing a chocolate according to claim 19, wherein 80% or more of an aroma component contained in the cacao raw material is able to be remained in the chocolate.

28. The method for producing a chocolate according to claim 23, wherein an aroma component in the chocolate comprises linalool.
